(19) United States
(12) Patent Application Publication
(10) Pub. No.: US 2008/0317170 A1
(43) Pub. Date: Dec. 25, 2008

(54) Embedding a Secondary Information Signal in a Channel Data Stream

(75) Inventors: Petrus Henricus Cornelius Bentvelsen, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,147

(22) PCT Filed: Jan. 7, 2005
(86) PCT No.: PCT/IB2005/050091

§ 371 Date: Sep. 9, 2008

(30) Foreign Application Priority Data
Jan. 19, 2004 (EP) 04100144.7
Oct. 20, 2004 (EP) 04105192.1

(51) Int. Cl. H04L 25/06

(52) U.S. Cl. 375/319

(57) ABSTRACT

The present invention relates to a method and a corresponding device for embedding a secondary information signal in a channel data stream of encoded primary information signal. In order to make it more difficult for unauthorized persons or devices to retrieve the location of storage of the secondary information signal or its content itself a device is proposed according to the present invention comprising:
an encoder (1) for encoding said primary information signal into a channel data stream,
a control unit (3) for controlling the DC content of said channel data stream,
a secondary information signal embedding unit (2) for embedding said secondary information signal in said channel data stream by using freedoms in the DC control, and
an adaptation unit (4) for adapting the DC control by making non-optimal, arbitrary or random choices of the DC control at a number of locations of said channel data stream.

The present invention relates to a method and a corresponding device for embedding a secondary information signal in a channel data stream of an encoded primary information signal. Further, the present invention relates a device and a corresponding method for extracting a secondary information signal in a channel data stream, to a computer program for implanting said method on a computer, and to a record carrier comprising the secondary information signal.

In WO02/15185 (PHNL000451) a method is described how to encode and decode a secondary information signal in a RLL code of a primary information signal. The secondary information signal is stored in the absolute polarity at a predetermined position; this polarity is set using the degree of freedom that exists in the choice of DC control bits.

The secondary information signal is a low bit-rate channel and can be used to store e.g. decryption keys for the content in the primary information signal. The key size is typically 128-512 bits or more. Since this key is typically a master key to access the content, it is essential that the retrieval of the key is very robust. The secondary information signal should be hidden in such a way that is difficult to extract the key by reverse engineering even if the technology becomes known.

The encoded primary information signal usually consists of a regular pattern of so-called frames; a frame consists of a synchronization pattern followed by a number of codewords. Within a frame there is some degree of freedom for the minimization of the DC content in the encoded bit stream. For example:
(i) Within the CD format there is a so-called EFM-sync, followed by 33 codewords. The sync and all codewords are followed by a 3-bit merging bit pattern. There are four possible choices of merging bit patterns. The merging bit pattern should be such that no runlength violations occur and the digital sum value (DSV) is minimized. In the case that more than two merging bit patterns are possible that fulfill the runlength constraints and have an opposite parity (number of transitions), the choice of merging bit pattern can be used to minimize the DSV. In part of the cases this will be at the expense of a less than optimal choice for DSV minimization.
(ii) Within the DVD format the data stream (or bit stream or channel bit stream) is organized in sync-frames. Each sync frame starts with a sync-pattern that is followed by 91 codewords. For each sync-pattern there are two alternatives with opposite parity: the primary sync and the secondary sync. The data bytes are translated into codewords, where several conversion tables are used. Which conversion table is used depends on the previous codeword, but there is also some degree of freedom in a part of the cases. This degree of freedom in combination with the choice of the sync allows DSV minimization.
(iii) Within the Blu-ray Disc format the data stream is organized in recording frames. A recording frame consists of a frame sync (of 20 channel bits length) followed by 1240 data bits. The sync bits and data bits are grouped in 28 units of 45 bits. Each group is followed by a DC control bit (28 bits in total), which can be used freely for DSV minimization of the channel bit stream.

In the known systems the bits of the secondary information signal are stored at fixed positions, e.g. in the CD-format at a fixed offset from the EFM-sync or after a fixed number of transitions following the EFM-sync. Also, the location in the data stream where the degree of freedom for DSV control is used to force the polarity to the desired value is fixed (e.g. the merging bit pattern preceding the EFM-sync pattern in the CD format). This has, among others, the following disadvantages:

If a sufficiently large channel data stream is available, the DC control algorithm can be deduced from this stream. In a channel data stream containing the secondary information signal, the location within a sync frame (or recording frame or EFM-frame) can become known at which the degree of freedom is used to control the bit polarity. At this location, for a part of the cases (typically 50%) a less than optimal choice is made for DC control. Although this location is generally not the same as the location where the secondary information signal bit is stored, knowing this location already reveals part of the secret. If the secondary information signal is embedded only in a part of the channel data stream (e.g. only in the control data sectors), the location of the secondary information signal area can become known after analysis of the DC control encoding statistics.

Further, if the secondary information signal is stored at a fixed location, this can be at a non-preferable location within a codeword. To enhance reliable detection, the DC-bit is preferably stored at locations in the modulation stream, which are well separated from polarity transitions (so bit-slip does not influence the quality of the secondary information signal) and are not in the shortest runlengths (because of the low modulation of the shortest runlength). For example, the preferable locations within an 8-to-16 modulation stream as used in DVD are in the runlengths of 4T and larger, and are separated at least 1 channel bit length from the transitions.

It is an object of the present invention to provide a device and a method for embedding a secondary information signal in a channel data stream of an encoded primary information signal which make it more difficult for unauthorized persons or devices to retrieve the location of storage of the secondary information signal or its content itself.

This object is achieved according to the present invention by a device as claimed in claim 1 comprising:
an encoder for encoding said primary information signal into a channel data stream,
a control unit for controlling the DC content of said channel data stream,
a secondary information signal embedding unit for embedding said secondary information signal in said channel data stream by using freedoms in the DC control, and
an adaptation unit for adapting the DC control by making non-optimal, arbitrary or random choices of the DC control at a number of locations of said channel data stream.

A corresponding method is defined in claim 11. The invention relates further to an extraction device and method as claimed in claims 12 and 16, respectively, to a computer program for implementing said method as claimed in claim 17, and to a record carrier comprising the secondary information signal as claimed in claim 18. Preferred embodiments of the invention are defined in the dependent claims.

The invention is based on the idea to provide DC control adaptations that do not have a fixed relation with the location of the secondary information signal in the channel data stream so that a location of the secondary information signal area is concealed. It is thus much more difficult for a user to find out where secondary information is stored in the channel data stream, so that he can not retrieve the DC control algorithm or the secondary information itself. By making non-optimal, arbitrary or random choices of the DC control at a number of locations of the channel data stream a non-compliant decoder can not distinguish between actual secondary information and such non-optimal, arbitrary or random choices which do not represent any secondary information.

In a preferred embodiment the addition of random elements in the DC control is proposed. Random elements can be inserted in the DC control algorithms in the following preferred ways:

In a (typically small) number of occasions and at random or fixed locations, the DC control algorithm makes a non-optimal choice. In this way locations where the degree of freedom in DC control is used to encode the secondary information signal cannot be traced by performing statistical analysis on the algorithm.

In the parts of the channel data stream that do not contain the secondary information, e.g. a channel key, a random bit pattern can be inserted into the primary signal encoder that embeds the secondary information signal. In this way the DC control strategy remains the same for the entire data stream, regardless of the presence of valid secondary information signal data, and analysis of the encoder statistics does not reveal the location of the secondary information signal data.

In a further embodiment it is proposed to use the degrees of freedom at different locations to encode the secondary information signal. In DVD the DC control is done by:
i) Choice of primary or secondary sync. The sync patterns have an opposite parity, and both choices are always possible. Therefore it is a guaranteed method of polarity control;
ii) Choice of main conversion table or substitution table for data symbols 0-87;
iii) State swap: if next state is state 1 or state 4 either of these states can be used as long as runlength constraints are preserved.

Instead of choosing one DC control location (typically: the sync pattern) to control the polarity of the secondary information signal bits, it is proposed in this embodiment to use further locations. In particular, state swaps and/or the selection of a main table or a substitution table are used for encoding of the secondary information signal in addition to the use of the primary or secondary sync.

In BD the DC-control is done by setting the DC-control bits in the data stream to such a value that the DSV of the modulation bit stream is minimized. Instead of using one DC-control bit to control the polarity of the secondary information signal bits, it is proposed in this embodiment to use further locations.

In further embodiments, as defined in claims 6 to 10, a location information specifying the location of the secondary information signal in said channel data stream is stored. This location information can be a fixed information which is predetermined and stored both on the encoding and the decoding side. But it can also be selected “on the fly” when embedding the secondary information signal in the channel data stream, but must then be transmitted to the decoding side in any way, e.g. together with the channel data stream as separate or embedded information, for instance, in encoded form included in the primary information signal or in a third information signal.

By the location information it can be specified at which position in different codewords and/or data frames, such as sync frames, subcode frames or recording frames, secondary information data, for instance secondary information bits, are stored. I.e., the position can be different in each codeword and/or each data frame.

It shall be noted that the idea of storing a location information defined in claims 6 to 10 can also be applied separate from the idea of making non-optimal, arbitrary or random choices of the DC control at a number of locations of said channel data stream as defined in claims 1 to 5. That is, the idea of using location information to indicate at which position in the channel data stream the secondary information can be found can also be used with other methods of embedding a secondary information in the channel data stream of a primary data stream, for instance in the method as described in WO02/15185.

There are generally two possibilities: either the position where the polarity is controlled is varied randomly or the position where the polarity is detected is varied randomly. Only in the latter case it is necessary that the decoder knows of the locations. The locations can either be agreed beforehand and thus stored in the stored in the storage of the encoder and the decoder, or the locations are embedded in one or another way in the data stream, e.g. on the disc, or are separately transmitted to the decoder.

The invention will now be explained in more detail with reference to the drawings in which:

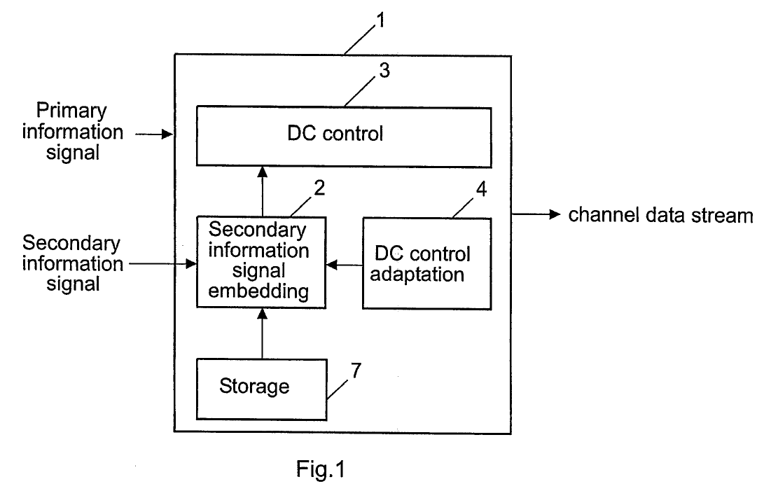

FIG. 1 shows a block diagram of an encoder according to the present invention,

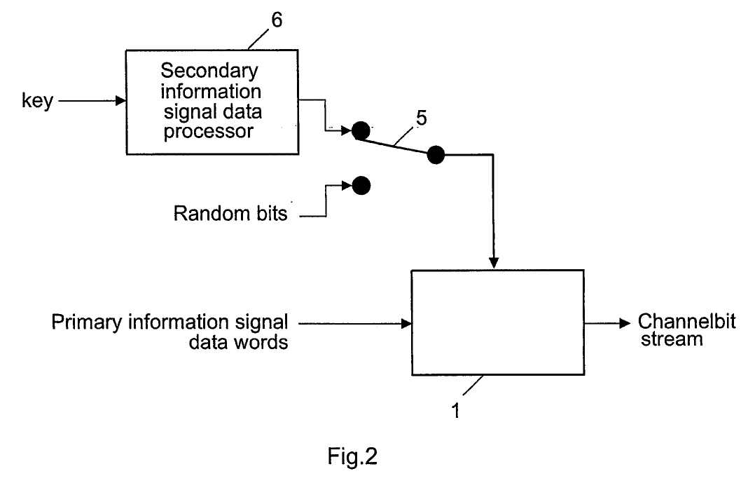

FIG. 2 shows a block diagram of an embodiment of the present invention,

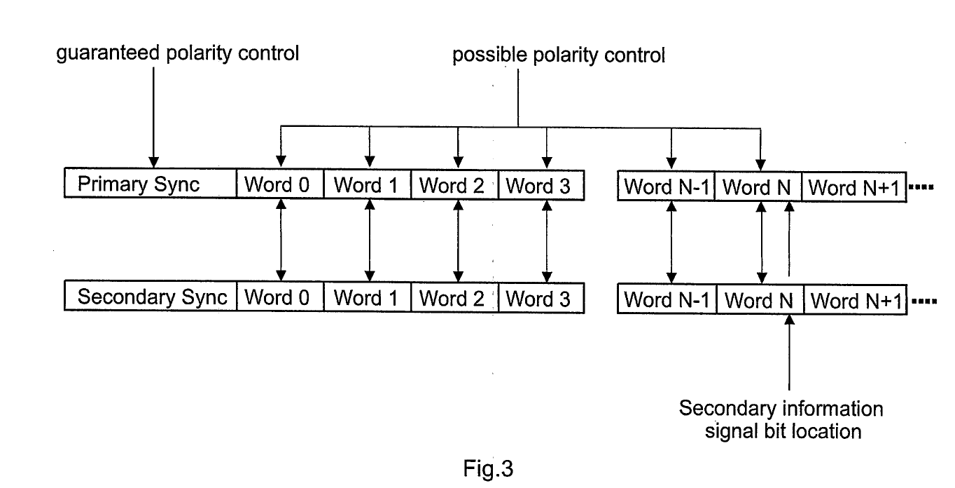

FIG. 3 illustrates a second embodiment of the present invention,

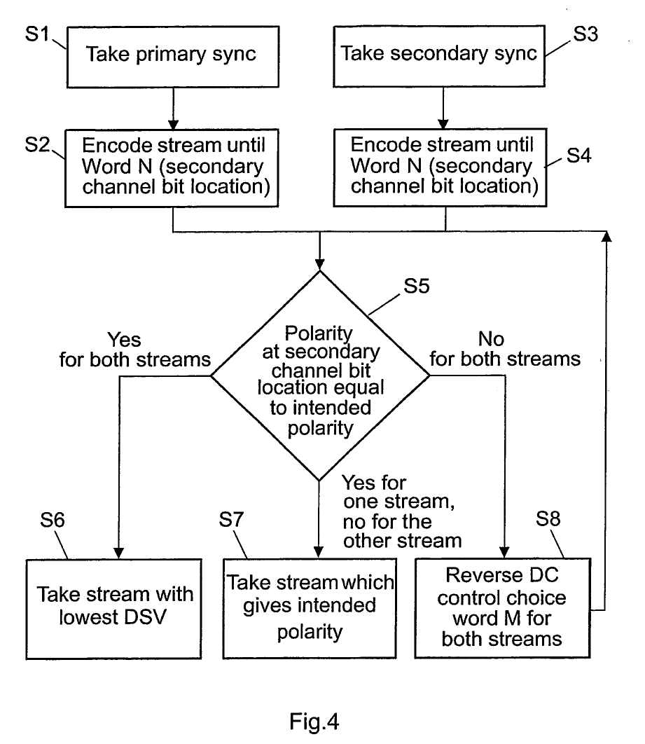

FIG. 4 shows a flow chart of the second embodiment,

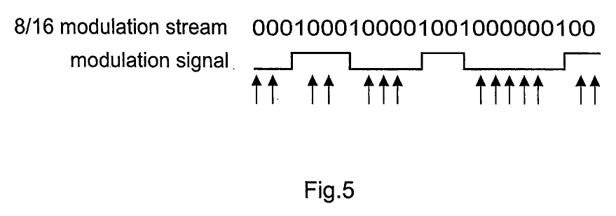

FIG. 5 shows preferred locations for embedding secondary information in a channel data stream,

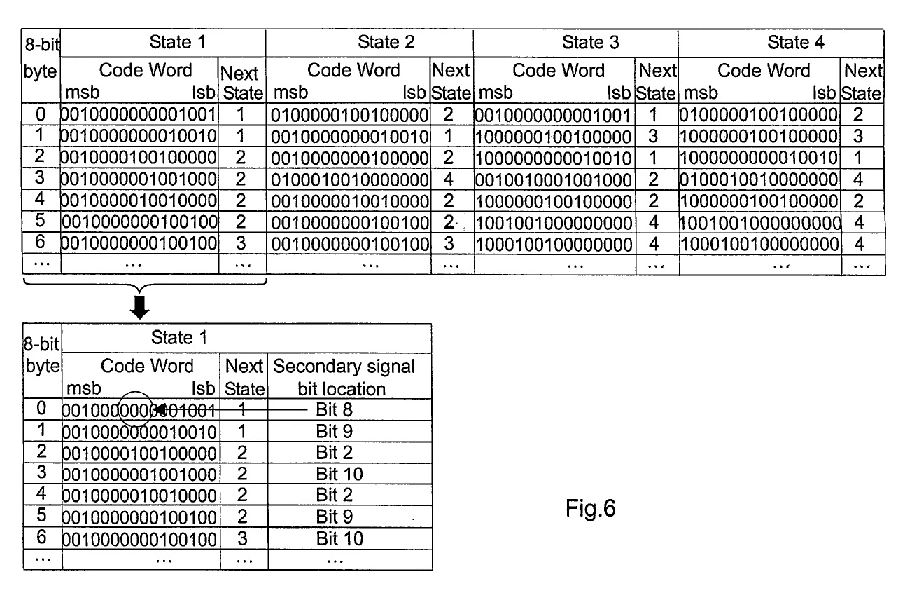

FIG. 6 illustrates a further embodiment of the present invention for use in DVD,

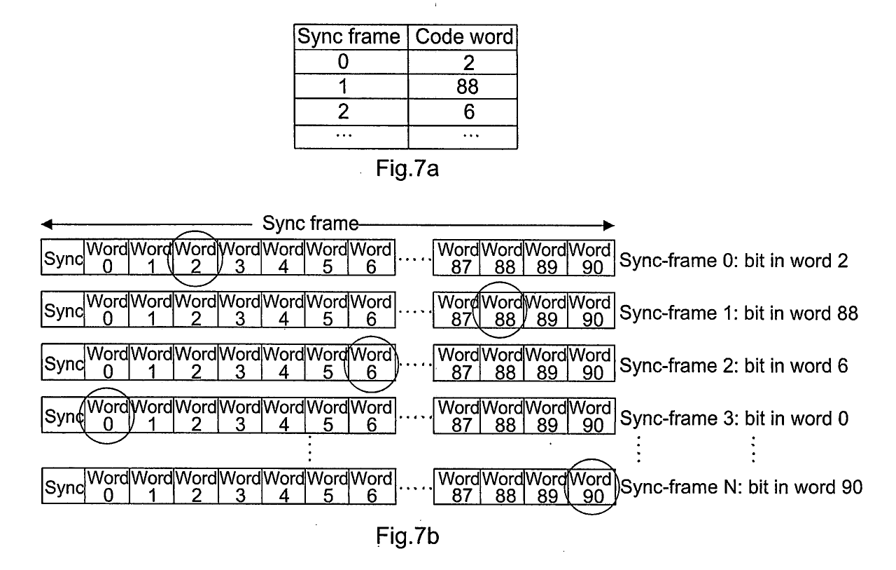

FIG. 7 illustrates a further embodiment of the present invention for use in DVD,

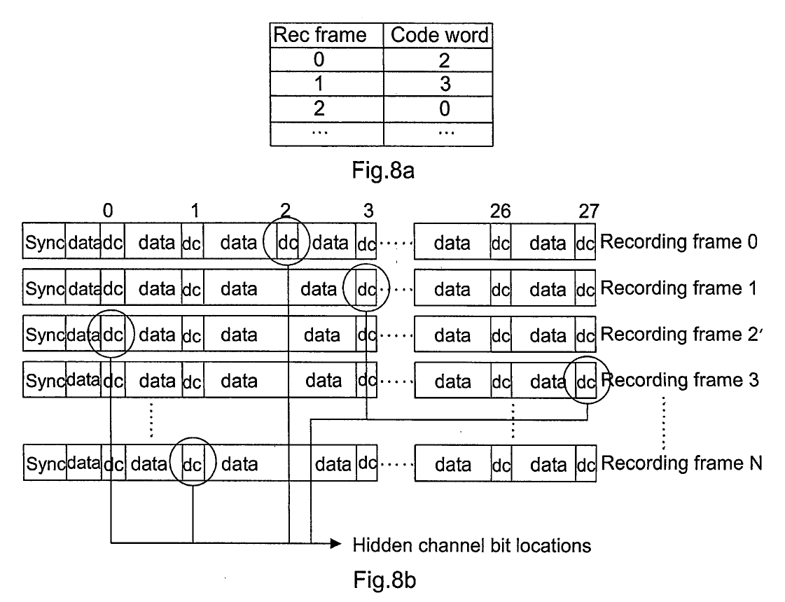

FIG. 8 illustrates a further embodiment of the present invention for use in BD,

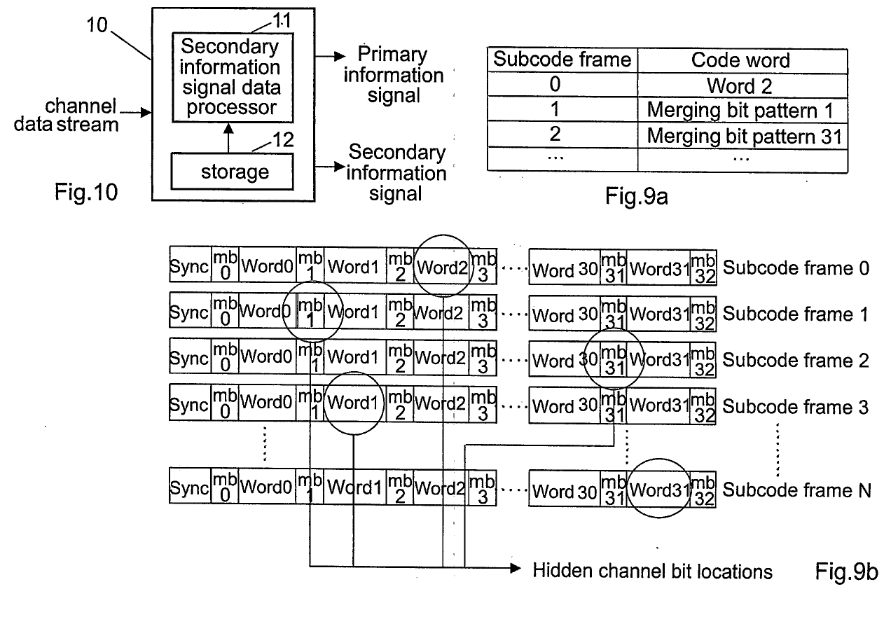

FIG. 9 illustrates a further embodiment of the present invention for use in CD,

FIG. 10 shows a block diagram of a first embodiment of a decoder according to the present invention,

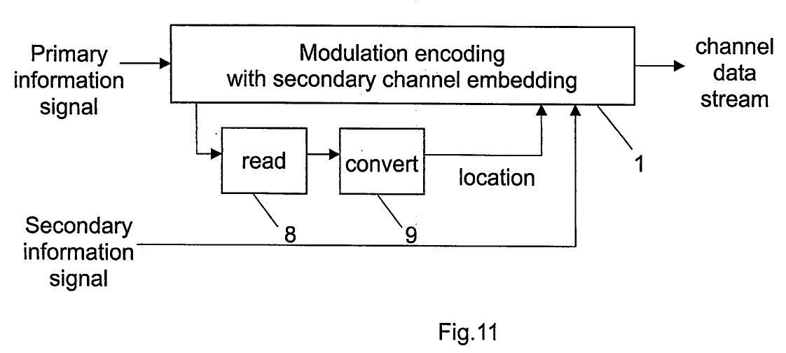

FIG. 11 shows a block diagram of another embodiment of an encoder according to the present invention,

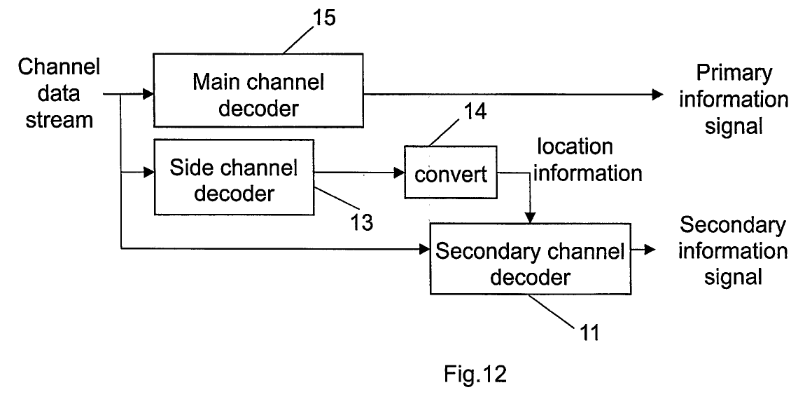

FIG. 12 shows a block diagram of an embodiment of a corresponding decoder according to the present invention, and

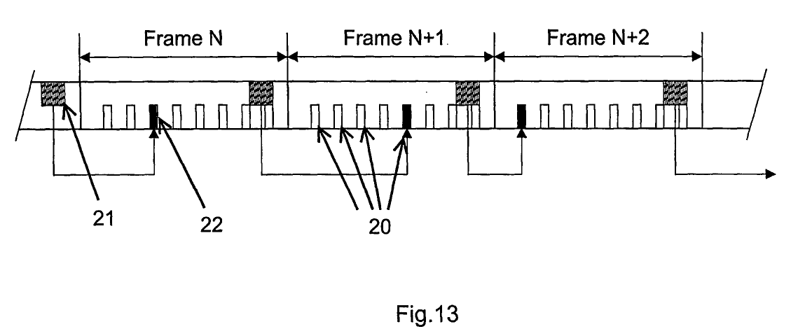

FIG. 13 illustrates the use of location information according to this embodiment.

FIG. 1 shows a block diagram schematically illustrating the present invention. Shown is an encoder 1 by which a primary information signal, for instance user data such as audio or video data, are encoded into a channel data stream for output to a channel, for instance for storage on a record carrier or for transmission over a transmission channel such as the internet. To embed a secondary information signal in this channel data stream, for instance to embed a hidden secret key in the primary information signal which shall not be easily detectable by non-compliant drives, a secondary information signal embedding unit 2 is provided. This unit 2 provides the secondary information signal to a DC control unit 3 which actually provides the embedding by using the degree of freedom that exists in the DC control. For instance, as described in WO02/15185, the secondary information signal is stored in the absolute polarity at a predetermined position, which polarity is set using the degree of freedom that exists in the choice of DC control bits.

In order to avoid that the location at which secondary information is stored in the channel data stream and that possibly the secondary information itself is detected, a DC control adaptation unit 4 is provided according to the present invention. This unit 4 is operative for controlling the DC control unit 3 by ensuring that at a number of locations of the channel data stream non-optimal, random or arbitrary choices of the DC control are made. This makes it more difficult for a non-compliant drive to detect at which location there is an actual secondary information signal stored and at which location there is arbitrary or random information stored.

Further, a storage unit 7 is generally provided in which a location information is stored defining positions at which secondary information is embedded in the channel data stream. This location information is either predetermined and fixed and is thus used as input information for the embedding unit 2, which thus knows at which locations non-optimal, random or arbitrary choices of the DC control can be made, or is determined during encoding is thereafter stored in the storage unit 7. In the first case the decoder also knows the fixed location information in advance, while in the second case the decoder must be informed about the selected locations, for instance by transmitting this location information as part of the channel data stream or separately therefrom, in order to enable the decoder to distinguish real secondary information from random or arbitrary information.

In a first embodiment of an encoder schematically shown in FIG. 2 random elements are inserted in the DC control algorithm. In this particular embodiment a secret key shall be stored as secondary information in the channel bit stream containing the primary information signal data words. By a switch 5 either secondary information signal data generated by a corresponding processor 6 or an arbitrary information, for instance a random bit pattern, is provided to the encoder 1. Particularly, in the parts of the channel data stream that do not contain the secondary information data the random bits are inserted into the primary information signal. The DC control algorithm remains the same for the entire data, stream, regardless of the presence of valid secondary information signal data or of random bits. It is thus not possible or very difficult to find the location of the secondary information signal data in the channel data stream by analysis of the encoder statistics.

In an embodiment, primarily used in DVD and illustrated in FIGS. 3 and 4, two data streams are encoded in the following way:

It is supposed that the secondary information signal bit is located in codeword N (FIG. 3). Then two streams up to codeword N are encoded, one with primary sync and one with secondary sync (steps S1-S4 in FIG. 4). Three different options then exist which are checked in step S5:
a. If at the bit location the two streams have opposite polarity, the appropriate stream is chosen to encode the secondary information signal bit value (S7).
b. If both streams have the same polarity, equal to the intended value to encode the secondary information signal bit, the stream with the lowest DSV (digital sum value) is chosen (S6).
c. If both streams have the same polarity, opposite to the intended value to encode the secondary information signal bit, the DSV choice (II (main-substitution table) or III (state swap) as mentioned above), that is done at codeword N is reversed in both streams (S8). If that does not have the desired effect or of reversing the choice is not possible, the same is done for codeword N−1, and so on. Eventually the stream with the lowest DSV is chosen, which is not strictly necessary.

This means that in this option the DC control choice can be reversed for both streams for codeword M, M meaning N−1, N−2, N−3, . . . depending on the number of times step S8 is passed during processing. M can also be chosen randomly for all codewords from 0 to N−1. Further, it is also possible to randomize which codeword should reverse the CD control choice. The secondary information signal is always guaranteed by the choice of the syncs in this embodiment. The DC control algorithm deviates from its optimum choices at quasi-random locations, and as a result is more difficult to extract secondary channel locations from encoding statistics. All words N−1 till 0 can be tried, but if all options do not lead to the intended polarity, there is always the sync choice that guarantees a polarity flip

In the known systems the secondary information signal is stored at a fixed location and the DC-bit is preferably stored at locations in the modulation stream, which are well separated from polarity transitions and are not in the shortest runlengths. For example, as shown in the diagram of FIG. 5, the preferable locations within an 8-to-16 modulation stream as used in DVD are in the runlengths of 4T and larger, and are separated at least 1 channel bit length from the transitions, i.e. preferred locations are indicated by arrows in FIG. 5.

To cope with this problem, in a further embodiment, which can be applied separately and independently from the above described embodiments, the secondary information signal bit location is not fixed, but specified separately for each codeword or a number of codewords. This specification is known at the encoder and at the decoder. For example, as shown in FIG. 6 for DVD, for each codeword (state 1 to state 4, in main table and substitution table) the secondary information signal channel bit is specified. The bit location must not necessarily be chosen at the optimum location in terms of maximum distance to the nearest transitions. For each codeword in each state and for both main table and substitution table, the secondary information signal bit location is specified.

To further complicate reverse engineering and weaken the relation between the polarity of the secondary information signal and its content a table can be used to specify the frame number (e.g. recording frame in Blu-ray Disc, sync frame in DVD, EFM frame in CD) and the codeword in that frame that contains the secondary information signal bit.

Within the codeword, the bit position can be fixed, or can be specified as described above and shown in FIG. 6. Zero, one or more secondary information signal bits can be hidden within a frame. The specification of the table is known at the encoder and at the decoder. In the FIGS. 7 and 8 it is shown how, for example, the secondary channel bits can be hidden for DVD and Blu-ray Disc, respectively.

In an embodiment for DVD shown in FIG. 7 each sync frame starts with a sync pattern, followed by 91 codewords of 16 channel bits. In this example the table looks as shown in FIG. 7a and the sync frames are shown in FIG. 7b. Every sync frame contains exactly 1 secondary information signal bit.

In an embodiment for Blu-ray Disc shown in FIG. 8 each recording frame starts with a sync pattern. Each of the 28 groups of 45 data bits is followed by a DC control bit. In this example the table looks as shown in FIG. 8a and the recording frames are shown in FIG. 8b. Every recording frame contains exactly 1 secondary information signal bit.

In an embodiment for CD shown in FIG. 9 each subcode frame starts with a sync pattern, followed by 33 codewords of 14 channel bits. The sync pattern and all codewords are followed by a merging bit pattern of 3 channel bits. In this example the table looks as shown in FIG. 9a and the subcode frames are shown in FIG. 9b. Every subcode frame contains exactly 1 secondary information signal bit.

The frame number in the tables shown in FIGS. 7a, 8a, 9a can be relative to some fixed position on the disc (e.g. relative to start of control data at sector 2F200h for DVD) or can be the frame number within an ECC-block (in DVD there are 416 sync frames in an ECC-block), an ECC-cluster (in Blu-ray Disc the 496 rows of an ECC-cluster are transformed in 496 recording frames), or a subcode frame (in CD a subcode frame consists of 98 EFM-frames).

The location information, i.e. the information in which codewords, in which data frames and/or at which positions in codewords and/or data frames is stored in the storage unit (7 in FIG. 1) and is transmitted to the decoder or agreed upon in advance between the encoder and the decoder so that it is fixed and also stored in the decoder.

An embodiment of a decoder according to the present invention is schematically shown as a block diagram in FIG. 10. In this embodiment the decoder 10 for decoding said channel data stream into a primary information signal a secondary information signal extracting unit 11 for extracting the secondary information signal from the channel data stream by detection of the DC control information in the channel data stream, and, preferably, a storage unit 12 for storing the location information specifying the location of the secondary information signal in the channel data stream corresponding to the location information stored in the storage unit of the encoder.

In the method described in WO0215185 as well as in the method described above DC-control is locally sacrificed to set a secondary channel bit to the appropriate value. In the above method, the DC control bit in the data bit stream, which is set to a specific value to encode the secondary channel bit, will be in e.g. 50% of the cases a non-optimal choice for minimization of the Digital Sum Value in the modulation bit stream. In method described in WO0215185, location of the secondary channel bit is decoupled from the location where the polarity is controlled; for example, channel bit location N is set to a specific value to control the polarity at channel bit location N+M.

A practical implementation of method described in WO0215185 is that the polarity control is done at a fixed position related to a frame sync (recording frame in BD, sync frame in DVD, EFM-frame in CD), and the detection of the secondary channel bit is done at the same or another fixed position relative to the sync. This has two disadvantages:
a) Statistical analysis of the encoded signal reveals the location where the polarity encoding is done (because here in e.g. 50% of the cases it will be a non-optimal choice). This does not directly reveal the secondary channel bits, but is anyway a strong hint of the presence of a secondary signal.
b) Depending on the choice of the location of the secondary channel bit, a fixed bit location relative to the sync will result in that sometimes the secondary channel bit is part of a short runlength, or will be the first channel bit of a runlength (or a combination of the two). In each case the robustness of the detection of the secondary channel bits will decrease.

A practical implementation of above described method of the invention is that a fixed DC control bit is chosen in a recording frame to encode the secondary channel. This might have the following disadvantages:
c. Statistical analysis of the encoded signal reveals the secondary channel bit location.
d. Since the secondary channel is stored in the data bit stream rather than in the NRZI channel bit stream, it is less secure. During decoding, the NRZI channel bit stream is converted into a modulation bit stream (here the polarity information is lost), and then 17PP decoded into a data bit stream. After this, the DC control bits are discarded. Modifying this last step can reveal the secondary signal bits.

A solution to overcome most of these problems (problems a)-c)) which has been described above is to use a look-up table to store the position in a modulation code word or a frame (see FIGS. 6-9). This, however, has the difficulty that the decoder has to know the table beforehand. A method to pass the look-up table information, more generally called location information, from the encoder to the decoder. Some implementations of this can provide a solution to problem d), because the table information can be stored in the modulation bit stream.

FIGS. 11 and 12 show and embodiment of an encoder and a corresponding decoder according to which the location of a secondary channel bit is encoded using another side channel, which can be the primary channel or a third channel. During encoding, a value N in this side channel can be set to a specific (predetermined) value to force a secondary channel bit position B; alternatively, the encoder, in particular a location information determination unit 8 thereof, can take the ‘as is’ value, e.g. read from the primary channel, to encode the secondary channel bit at the position derived from this side channel's value using the encoder 1. By use of a converter 9 the value N retrieved from the side channel is converted into a bit location B using a predefined function B=f(N).

During decoding, as shown in FIG. 12, besides decoding the primary information signal using a primary channel decoder 15, the value N of the side channel is evaluated by a location information decoder 13 and converted to B by a converter 14. This value B is used to search the secondary channel's bit position and to decode the secondary information signal from the channel data stream using a secondary channel decoder 11.

The value N in this side channel is read out in the same frame as where the secondary channel bit is encoded, in the previous frame, or at another location.

The secondary channel bit location as encoded in the side channel can be e.g.
a) A bit position relative to a frame sync (CD, DVD, BD).
b) A modulation word (CD, DVD), detection at a fixed bit position within that modulation word.
c) A bit position in a specific modulation word at a fixed location within a frame.
d) A DC-control bit in a recording frame (BD).

The secondary channel bit can be encoded as e.g.:

a) Polarity of a specific bit position.

b) Value of a DC-control bit.

c) Value of a specific data bit position.

d) Value of a specific modulation word or data byte.

An example of the use of location information is shown in the graph of FIG. 13. Each has several possibilities 20 for storing a secondary channel bit 22. According to this example the location information 21 for a secondary channel bit embedded in frame N is stored in the previous frame N−1.

1. Device for embedding a secondary information signal in a channel data stream of an encoded primary information signal comprising:
an encoder (1) for encoding said primary information signal into a channel data stream,
a control unit (3) for controlling the DC content of said channel data stream,
a secondary information signal embedding unit (2) for embedding said secondary information signal in said channel data stream by using freedoms in the DC control, and
an adaptation unit (4) for adapting the DC control by making non-optimal, arbitrary or random choices of the DC control at a number of locations of said channel data stream.

2. Device as claimed in claim 1, wherein said adaptation unit (4) is operative for adding random elements in the DC control.

3. Device as claimed in claim 2, wherein said adaptation unit (4) is operative for making non-optimal choices of the DC control at a number of random or fixed locations of said channel data stream.

4. Device as claimed in claim 2, wherein said adaptation unit (4) is operative for making random or non-optimal choices of the DC control at locations of said channel data stream where no secondary information signal shall be embedded.

5. Device as claimed in claim 1, wherein said adaptation unit (4) is operative for making random or non-optimal choices of the DC control at different locations of said channel data stream by controlling the encoder to make a state swap or to select a main table or a substitution table for encoding of the primary information signal.

6. Device as claimed in claim 1, further comprising a storage unit (7) for storing a location information specifying the location of the secondary information signal in said channel data stream.

7. Device as claimed in claim 6, wherein said secondary information signal embedding unit (2) is adapted for embedding secondary information data at different locations within different codewords and/or different data frames.

8. Device as claimed in claim 6, wherein said storage unit (7) is adapted for storage of said location information in a look-up table.

9. Device as claimed in claim 6, wherein said storage unit (7) is adapted for storing said location information in encoded form in said primary information signal or in a third information signal to be embedded in said channel data stream.

10. Device as claimed in claim 8, further comprising a location information determination unit (8, 9) for determining said location information based on a predetermined setting or an information read from said primary information signal or a third information signal.

11. Method of embedding a secondary information signal in a channel data stream of an encoded primary information signal comprising the steps of:
encoding said primary information signal into a channel data stream,
controlling the DC content of said channel data stream,
embedding said secondary information signal in said channel data stream by using freedoms in the DC control, and
adapting the DC control by making non-optimal, arbitrary or random choices of the DC control at a number of locations of said channel data stream.

12. Device for extracting a secondary information signal from a channel data stream of an encoded primary information signal comprising:
a decoder (10) for decoding said channel data stream into a primary information signal, a
secondary information signal extracting unit (11) for extracting said secondary information signal from said channel data stream by detection of the DC control information in said channel data stream by use of location information specifying the location of said secondary information signal in said channel data stream.

13. Device as claimed in claim 12, further comprising a storage unit (12) for storing said location information.

14. Device as claimed in claim 12, further comprising a location information decoder (13, 14) for retrieving said location information from said channel data stream.

15. Device as claimed in claim 14, wherein said location information decoder (13, 14) is adapted for decoding a third information signal carrying said location information from said channel data stream or for decoding said information signal from said primary information signal.

16. Method for extracting a secondary information signal from a channel data stream of an encoded primary information signal comprising the steps of:
decoding said channel data stream into a primary information signal,
extracting said secondary information signal from said channel data stream by detection of the DC control information in said channel data stream by use of location information specifying the location of said secondary information signal in said channel data stream.

17. Computer program comprising program code means for causing a computer to carry out the steps of the method as claimed in claim 11 when said computer program is run on a computer.

18. A record carrier comprising a secondary information signal in a channel data stream of an encoded primary information signal, the secondary information being embedded in said channel data stream by using freedoms in the DC control and by adapting the DC control by making non-optimal, arbitrary or random choices of the DC control at a number of locations of said channel data stream.
